(19) United States
(12) Patent Application Publication
(10) Pub. No.: US 2025/0055093 A1
(43) Pub. Date: Feb. 13, 2025

(54) POWER STORAGE DEVICE AND METHOD OF MANUFACTURING THE POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yuki SATO, Toyota-shi (JP); Yozo UCHIDA, Toyota-shi (JP); Satoshi FUJIMURA, Toki-shi (JP); Nozomi TATEYAMA, Okazaki-shi (JP); Masahiro UCHIMURA, Miyoshi-shi (JP); Masataka ASAI, Toyota-shi (JP); Shigeru MATSUMOTO, Toyohashi-shi (JP); Takashi TAKIMOTO, Kosai-shi (JP); Shunsuke NAKAMURA, Hamamatsu-shi (JP); Keitaro MACHIDA, Hamamatsu-shi (JP)

(21) Appl. No.: 18/636,269

(22) Filed: Apr. 16, 2024

(30) Foreign Application Priority Data
Aug. 9, 2023 (JP) 2023-130169

(51) Int. Cl. H01M 50/176; H01M 50/186; H01M 50/553; H01M 50/562

(52) U.S. Cl. CPC H01M 50/176; H01M 50/186; H01M 50/553; H01M 50/562

(57) ABSTRACT

A power storage device has a case member, a terminal member, and a resin member subjected to insert molding to fix the terminal member to the case member. The resin member is made of a resin material including a thermoplastic main resin having a first glass transition temperature equal to or higher than 70° C., a thermoplastic elastomer, and a filler. The elastomer has a second glass transition temperature that is equal to or higher than −10° C. and equal to or lower than 20° C. and a third glass transition temperature equal to or lower than −40° C.

### CROSS-REFERENCE TO RELATED APPLICATIONS

This application is based upon and claims the benefit of priority from the prior Japanese Patent Application No. 2023-130169 filed on Aug. 9, 2023, the entire contents of which are incorporated herein by reference.

### BACKGROUND

### Technical Field

The disclosure relates to a power storage device in which a terminal member is fixed via a resin member to a case member that constitutes a case, and also relates to a method of manufacturing the power storage device.

### Related Art

As a power storage device, a battery is known in which positive and negative terminal members are fixed via respective resin members to a case member (specifically, a case lid member in the form of a rectangular plate) that constitutes a case in the shape of a rectangular parallelepiped box. Specifically, each of the positive and negative terminal members is inserted through an insertion hole formed in the case lid member, to extend from the inside of the case to the outside, and the resin member is hermetically joined to the case lid member and the terminal member while insulating these members from each other, to fix the terminal member to the case lid member.

In manufacturing the battery as described above, the resin member may be subjected to insert molding. That is, in a condition where the terminal member is inserted through the insertion hole of the case lid member, the resin member is insert molded to fix the terminal member to the case lid member via the resin member. One example of the related art for insert molding the resin member is described in Japanese unexamined patent application publication No. 2022-079172 (JP 2022-079172 A).

### SUMMARY

### Technical Problems

In order to fix the terminal member to the case lid member with the resin member, the resin member needs to have a certain degree of hardness. Therefore, a main resin having a glass transition temperature sufficiently higher than room temperature (25° C.), e.g., polyphenylene sulfide (PPS: glass transition temperature=90° C.), may be used as a main resin that forms the resin member.

In addition, a filler, such as glass fiber, carbon fiber, or ceramic powder, may be further added to the resin material so as to further improve the strength of the resin member and to make the linear expansion coefficient of the resin material that forms the resin member closer to that of metal that forms the terminal member and the case member.

Meanwhile, an elastomer that easily deforms elastically may be further added to the resin material so as to increase the toughness of the resin member, for the reason as follows. The elastomer thus added disperses stress applied to the resin member and prevents cracks from forming in the resin member or extending when the resin member is molded and cooled to room temperature or when the battery is in actual use.

However, it has been found that, even in the case where the resin member is molded using the resin material including the main resin, elastomer, and filler, when the temperature of the resin member is set to room temperature (25° C.) after molding, cracks may form due to cohesive failure along the boundary between the resin member and the terminal member, in a region of the resin member close to the boundary, under the stress generated in the resin member due to thermal expansion differences between the case member and terminal member, and the resin member.

The disclosure was made in view of the situation as described above, and provides a power storage device in which a resin member is molded using a resin material including a main resin having a first glass transition temperature sufficiently higher than room temperature, an elastomer, and a filler, and in which formation of cracks in the resin member can be curbed when the power storage device is placed at room temperature (25° C.). The disclosure also provides a method of manufacturing the power storage device.

### Means of Solving the Problems

(1) One aspect of the disclosure for solving the above problem is a power storage device including a case member having an insertion hole, a terminal member inserted through the insertion hole of the case member, and a resin member subjected to insert molding and hermetically joined to the case member and the terminal member while insulating the case member and the terminal member from each other, to fix the terminal member to the case member. In the power storage device, the resin member comprises a resin material including a thermoplastic main resin having a first glass transition temperature Tg1 that is equal to or higher than 70° C. (Tg1≥70), a thermoplastic elastomer, and a filler, and the elastomer has a second glass transition temperature Tg2 that is equal to or higher than −10° C. and equal to or lower than 20° C. (−10≤Tg2≤20) and a third glass transition temperature Tg3 that is equal to or lower than −40° C. (Tg3≤−40).

In the power storage device described above, the main resin of the resin material that forms the resin member has the first glass transition temperature Tg1 that is equal to or higher than 70° C., while the elastomer has the second glass transition temperature Tg2 that is equal to or higher than −10° C. and equal to or lower than 20° C. and the third glass transition temperature Tg3 that is equal to or lower than −40° C. With this arrangement, formation of cracks in the resin member can be curbed when the power storage device is placed at room temperature (25° C.).

The reason for this may be considered as follows. That is, the glass transition temperature Tg1 of the main resin included in the resin material is sufficiently higher than room temperature; therefore, the main resin is in a glassy state under room temperature and is hard and strong but has low toughness.

Here, the case where the elastomer included in the resin material has only one glass transition temperature Tg2 or it has two glass transition temperatures Tg2, Tg3 and both of the glass transition temperatures Tg2, Tg3 are higher than room temperature or slightly lower than room temperature (specifically, −10° C. to 25° C.) (i.e., the case where the glass transition temperatures Tg2, Tg3 are equal to or higher than −10° C.) will be considered. In this case, where the resin member is at room temperature, the elastomer is in a glassy state, or the elastomer is hard because the room temperature is close to the glass transition temperatures Tg2, Tg3. Therefore, the resin member (resin material) is also hard and has high elasticity. Thus, when there are thermal expansion differences between the case member and terminal member and the resin member, large stress is applied to the resin member, causing cracks to easily form in the resin member.

On the other hand, the case where the only glass transition temperature Tg2 or both of the two glass transition temperatures Tg2, Tg3 of the elastomer described above are sufficiently lower than room temperature (specifically, −40° C. or lower) will be considered. In this case, where the resin member is at room temperature, the elastomer is in a sufficiently soft rubber-like elastic state. Therefore, when there are thermal expansion differences between the case member and terminal member and the resin member, the elastomer, which is too soft and deforms easily, cannot sufficiently disperse stress, and large stress is applied to the main resin of the resin member, causing cracks to easily form in the resin member.

In contrast, according to this disclosure, the elastomer included in the resin material has the second glass transition temperature Tg2 (−10° C. to 20° C.) that is slightly lower than room temperature, and the third glass transition temperature Tg3 (equal to or lower than −40° C.) that is sufficiently lower than room temperature, as described above. Therefore, it may be considered that where the resin member is at room temperature, a part of the elastomer is hard because the second glass transition temperature Tg2 is close to room temperature, but the rest of the elastomer remains sufficiently soft because the third glass transition temperature Tg3 is sufficiently lower than room temperature, and the elastomer as a whole is moderately hard (moderately soft). As a result, even if there are thermal expansion differences between the case member and terminal member and the resin member, the elastomer with moderate hardness deforms and disperses stress, so that the stress on the main resin of the resin member can be reduced, and formation of cracks in the resin member can be curbed.

In the case where the only one glass transition temperature Tg2 or both of the two glass transition temperatures Tg2, Tg3 of the elastomer described above are within the temperature range (higher than −40° C. and lower than −10° C.) between the two temperature ranges (equal to or higher than −10° C., equal to or lower than −40° C.) mentioned above, the elastomer is also moderately hard when the resin member is at room temperature. Therefore, it may be considered that the elastomer deforms and disperses stress, resulting in reduction of the stress on the main resin of the resin member, and cracks are less likely or unlikely to appear in the resin member. In these cases, however, the hardness of the elastomer as a whole tends to increase and the stress-reducing effect of the elastomer tends to be easily reduced when the temperature at which the power storage device is held becomes slightly lower (e.g., about 10 to 20° C.) than room temperature.

In contrast, according to this disclosure, the elastomer has two glass transition temperatures that are significantly different from each other: the second glass transition temperature Tg2 (−10° C. to 20° C.) that is slightly lower than room temperature and the third glass transition temperature Tg3 (below −40° C.) that is sufficiently lower than room temperature. Therefore, even if the temperature at which the power storage device is held drops slightly from room temperature, the elastomer remains moderately soft so that the stress-reducing effect of the elastomer can be maintained and formation of cracks in the resin member can be curbed.

Examples of the “power storage device” include secondary batteries, such as a lithium-ion secondary battery, sodium-ion secondary battery, and a calcium-ion secondary battery, and capacitors, such as a lithium-ion capacitor.

The term “main resin” refers to a material with the highest weight percentage among materials that constitute the resin material of the resin member. For example, thermoplastic resins, such as polyphenylene sulfide (PPS), polyetheretherketone (PEEK), polytetrafluoroethylene (PTFE), and perfluoroalkoxyalkane (PFA), having the first glass transition temperature Tg1 equal to or higher than 70° C. may be used as the “thermoplastic main resin having the first glass transition temperature Tg1 that is equal to or higher than 70° C.”.

Examples of the “thermoplastic elastomer” include a thermoplastic polyurethane elastomer (TPU) obtained from diisocyanate such as 4,4′-diphenylmethane diisocyanate (MDI) and high molecular weight diol, and so forth. Further, the high molecular weight diol may be selected from, for example, polyester diol (PES), polyether diol (PET), polycaprolactonediol (PCL), polycarbonate diol (PCD), etc. As the elastomer, an elastomer having two glass transition temperatures Tg2, Tg3 may be used, or a mixture of an elastomer having only the second glass transition temperature Tg2 and an elastomer having only the third glass transition temperature Tg3 may be used.

Examples of the “filler” include glass filler made of alkali glass, E-glass, etc., alumina filler made of alumina, potassium titanate filler made of potassium titanate, etc. The shape of the “filler” includes, for example, spherical, plate-like, fibrous, needle-like, and so forth.

The resin material may include materials other than the main resin, elastomer, and filler described above.

The first glass transition temperature Tg1 is preferably equal to or lower than 150° C. (70≤Tg1≤150).

The third glass transition temperature Tg3 is preferably equal to or higher than −140° C. (−140≤Tg3≤−40).

To more appropriately prevent cracks from appearing in the resin member, it is preferable to bring the value of the linear expansion coefficient α3 of the resin material closer to the respective values of the linear expansion coefficient α1 of the metal forming the case member and the linear expansion coefficient α2 of the metal forming the terminal member. Specifically, it is preferable to set the linear expansion coefficient α3 of the resin material within the range of α1±0.8×10⁻⁵ (1/K) and α2±0.8×10⁻⁵ (1/K) with respect to the linear expansion coefficient α1 of the metal forming the case member and the linear expansion coefficient α2 of the metal forming the terminal member.

(2) In the power storage device described in (1), the third glass transition temperature Tg3 may be equal to or lower than −60° C. (Tg3≤−60).

To guarantee the weather resistance of the power storage device, a cooling/heating cycle test (the upper limit temperature: 65° C. to 90° C., the lower limit temperature: −40° C. to −20° C.) may be conducted on the power storage device. It has been found that when the cooling/heating cycle test is conducted, cracks may form in a region of the resin member near its boundary with the terminal member, and the cracks may further develop or extend to break the seal between the terminal member and the resin member.

When the power storage device is cooled below room temperature, the thermal expansion differences between the case member and terminal member and the resin member increase, and the stress on the resin member increases; therefore, the relationship with the lower limit temperature is particularly important. When the resin member reaches the lower limit temperature (−40° C. to −20° C.) in the cooling/heating cycle test, the elastomer as a whole is in a hard glassy state or in a hard state that has not reached glass transition if the third glass transition temperature Tg3 of the elastomer is higher than or close to this lower limit temperature. Therefore, it may be considered that since the resin member (resin material) also becomes hard and highly elastic, large stress is applied to the resin member due to the thermal expansion differences between the case member and terminal member and the resin member, and cracks are more likely to appear in the resin member.

In contrast, in the power storage device described above, the third glass transition temperature Tg3 is set to be equal to or lower than −60° C. (Tg3≤−60 (° C.)), which is sufficiently lower than the lower limit temperature (−40° C. to −20° C.). Therefore, the elastomer remains moderately soft even at the lower limit temperature mentioned above, which makes it possible to maintain the stress-reducing effect of the elastomer and curb formation of cracks in the resin member. As a result, a good seal between the terminal member and the resin member can be maintained even when the power storage device is subjected to the cooling/heating cycle test with the lower limit temperature of −40° C. to −20° C.

(3) In the power storage device described in (1) or (2), the terminal member may include a terminal seal portion to which the resin member is hermetically joined, and terminal nanocolumns with a height of 50 nm or more formed by joining particles derived from a metal that forms the terminal member and having a diameter of 100 nm or less together like strings of beads, into the form of columns, may stand numerously on a surface of the terminal seal portion. The resin member may be hermetically joined to the terminal seal portion with the resin material filling gaps between the terminal nanocolumns standing numerously.

In the power storage device described above, the terminal nanocolumns described above stand together in large numbers on the surface of the terminal seal portion of the terminal member, and the gaps between the terminal nanocolumns are filled with the resin material, so that the resin member is hermetically joined to the terminal seal portion. With this arrangement, the joint strength of the terminal seal portion of the terminal member and the resin member can be increased, and a good seal between the terminal member and the resin member can be maintained.

The particles that constitute the terminal nanocolumns and are derived from the metal forming the terminal member include, for example, particles made of the metal mentioned above, particles made of oxides of the above metal, and particles made of the above metal and the oxides of the above metal.

(4) Another aspect of the disclosure is a method of manufacturing a power storage device including a case member having an insertion hole, a terminal member inserted through the insertion hole of the case member, and a resin member subjected to insert molding and hermetically joined to the case member and the terminal member while insulating the case member and the terminal member from each other, to fix the terminal member to the case member, wherein the resin member comprises a resin material including a thermoplastic main resin having a first glass transition temperature Tg1 that is equal to or higher than 70° C. (Tg1≥70), a thermoplastic elastomer, and a filler, and wherein the elastomer has a second glass transition temperature Tg2 that is equal to or higher than −10° C. and equal to or lower than 20° C. (−10≤Tg2≤20) and a third glass transition temperature Tg3 that is equal to or lower than −40° C. (Tg3≤−40). The method of manufacturing the power storage device includes an insert molding of insert molding the resin member while the terminal member is inserted through the insertion hole of the case member, and the insert molding comprises molding the resin member, using the resin material including the main resin having the first glass transition temperature Tg1, the elastomer having the second glass transition temperature Tg2 and the third glass transition temperature Tg3, and the filler.

According to the method of manufacturing the power storage device described above, the resin member is molded using the resin material including the main resin, elastomer, and filler described above in the insert molding, so that the power storage device can be manufactured in which formation of cracks in the resin member is curbed in a condition where the power storage device is placed at room temperature (25° C.).

(5) In the method of manufacturing the power storage device described in (4), the terminal member may include a terminal seal portion to which the resin member is hermetically joined, and terminal nanocolumns with a height of 50 nm or more formed by joining particles derived from a metal that forms the terminal member and having a diameter of 100 nm or less together like strings of beads, into the form of columns, may stand numerously on a surface of the terminal seal portion. The resin member may be hermetically joined to the terminal seal portion with the resin material filling gaps between the terminal nanocolumns standing numerously. The method may further include a terminal nanocolumn forming of applying a pulse oscillation laser beam to the terminal seal portion of the terminal member while shifting an irradiation position, to form the terminal nanocolumns standing numerously on the terminal seal portion, before the insert molding, and the insert molding may comprise molding the resin member while filling gaps between the terminal nanocolumns standing numerously on the terminal seal portion with the resin material.

According to the method of manufacturing the power storage device described above, the terminal nanocolumns described above are formed on the surface of the terminal seal portion by applying the laser beam to the surface as described above in the terminal nanocolumn forming. Thus, the terminal nanocolumns can be easily formed on the terminal seal portion. Then, the resin member is molded with the resin material filling gaps between the terminal nanocolumns in the insert molding; therefore, the joint strength of the terminal seal portion of the terminal member and the resin member can be increased, and a good seal can be maintained between the terminal member and the resin member.

### BRIEF DESCRIPTION OF THE DRAWINGS

FIG. 1 is a perspective view of a battery according to one embodiment;

FIG. 2 is a partially broken cross-sectional view of the battery according to the embodiment, taken along the battery height direction and the battery width direction;

FIG. 3A is a partially enlarged cross-sectional view of a terminal member, a resin member, and their vicinity of the battery according to the embodiment, which view is taken along the battery height direction and the battery width direction;

FIG. 3B is a partially enlarged cross-sectional view of the terminal member, resin member, and their vicinity of the battery according to the embodiment, which view is taken along the battery height direction and the battery thickness direction;

FIG. 4 is a partially enlarged cross-sectional view of a surface and its vicinity of a terminal seal portion (lid seal portion) of the battery according to the embodiment;

FIG. 5 is an explanatory view showing a cross section of a resin material in connection with a method of measuring the linear expansion coefficient of the resin material;

FIG. 6 is a flowchart of a method of manufacturing the battery according to the embodiment;

FIG. 7 is an explanatory view showing a terminal nanocolumn formation process (lid nanocolumn formation process) in connection with the method of manufacturing the battery according to the embodiment;

FIG. 8A is an explanatory view of an insert molding process in which the terminal members are inserted through insertion holes of a case lid member, in connection with the method of manufacturing the battery according to the embodiment;

FIG. 8B is an explanatory view of the insert molding process in which the resin members are molded, in connection with the method of manufacturing the battery according to the embodiment; and

FIG. 9 is a graph showing the relationship between the number of cooling/heating cycles in a cooling/heating cycle test and the length of cracks generated in the resin members, with respect to lid assemblies according to Example and Comparative Examples 1, 2.

### DETAILED DESCRIPTION OF THE EXEMPLARY EMBODIMENTS

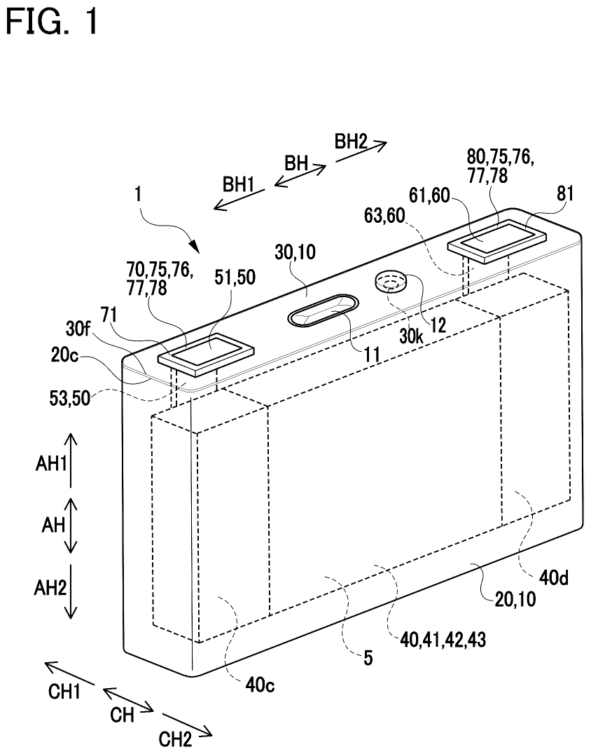

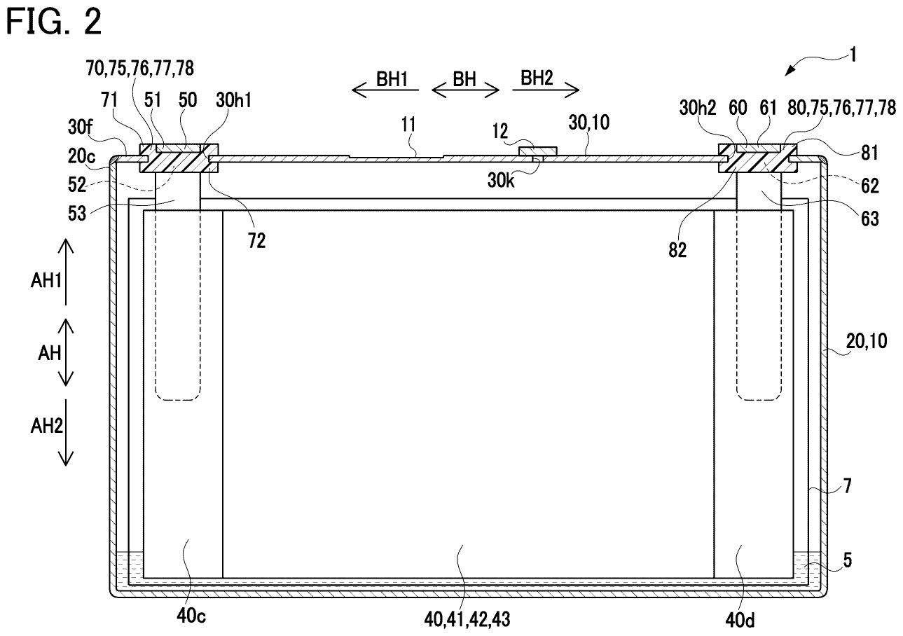

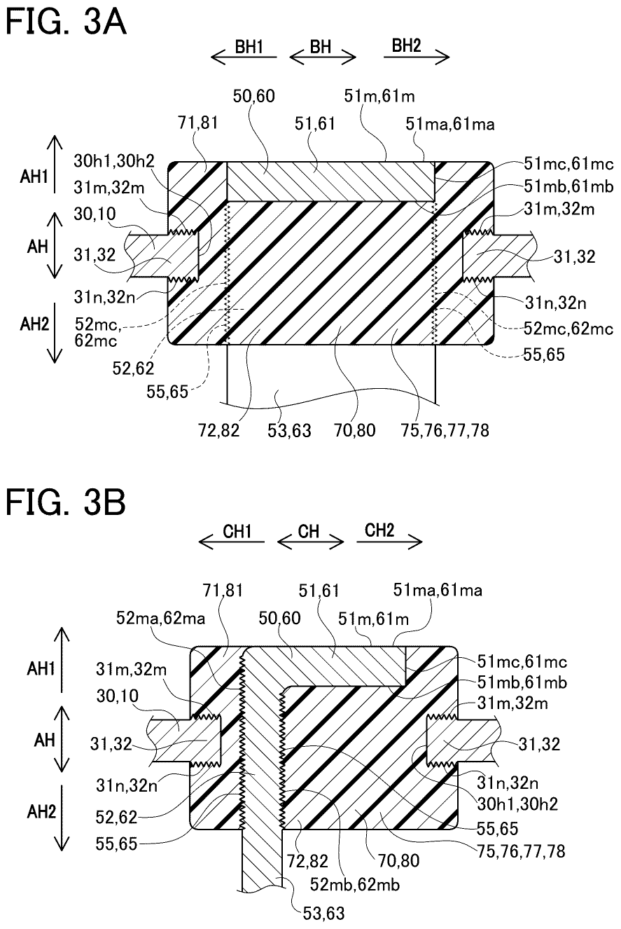

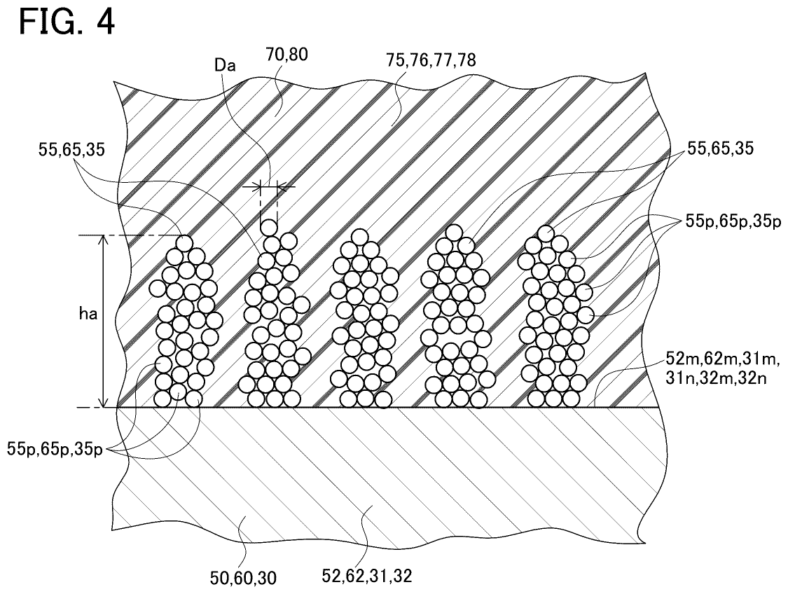

In the following, one embodiment of the disclosure will be described with reference to the drawings. FIG. 1 is a perspective view of a battery (one example of the power storage device of the disclosure) 1 according to the embodiment, and FIG. 2 is a partially broken cross-sectional view of the battery 1. FIG. 3A and FIG. 3B are partially enlarged cross-sectional views of a terminal member 50, 60, a resin member 70, 80, and their vicinities. FIG. 4 is a partially enlarged cross-sectional view of a surface 52m, 62m of a terminal seal portion 52, 62, etc., and its vicinity. In the following description, the battery height direction AH, battery width direction BH, and battery thickness direction CH of the battery 1 are defined as the directions indicated in FIG. 1 and FIG. 2. The battery 1 is a sealed lithium-ion secondary battery having a rectangular (rectangular parallelepiped) shape, which is installed on a vehicle, such as a hybrid vehicle, plug-in hybrid vehicle, or an electric vehicle.

The battery 1 consists of a case 10, an electrode body 40 housed in the case 10, a terminal member 50 of the positive electrode fixed to the case 10 via the resin member 70, a terminal member 60 of the negative electrode fixed to the case 10 via the resin member 80, and so forth. In the case 10, the electrode body 40 is covered with a bag-like insulating holder 7 made from an insulating film. The case 10 also contains electrolyte 5, and the electrode body 40 is impregnated with a part of the electrolyte 5, while the rest of the electrolyte 5 is collected and kept on a bottom wall of the case 10.

The case 10 is shaped like a rectangular parallelepiped box and made of metal (aluminum in this embodiment). The case 10 consists of a case body 20 that is in the form of a rectangular tube with a bottom and a rectangular opening portion 20c and houses the electrode body 40 therein, and a case lid member 30 in the form of a rectangular plate that closes the opening portion 20c of the case body 20. In this embodiment, the case lid member 30 corresponds to the “case member” mentioned above. The opening portion 20c of the case body 20 and a peripheral portion 30f of the case lid member 30 are hermetically welded together over the entire circumference thereof.

The case lid member 30 of the case 10 is provided with a safety valve 11 that breaks and opens when the internal pressure of the case 10 exceeds the valve opening pressure. The case lid member 30 is also provided with a liquid inlet 30k that extends through the case lid member 30, and the liquid inlet 30k is hermetically sealed with a disc-shaped sealing member 12 made of aluminum.

The electrode body 40 housed in the case 10 is of a rectangular parallelepiped, stacked type, and has a plurality of positive electrode sheets 41 and a plurality of negative electrode sheets 42 alternately stacked in the battery thickness direction CH via separators 43 each made from a porous resin film. Each of the positive electrode sheets 41, negative electrode sheets 42, and separators 43 has a rectangular shape extending in the battery height direction AH and the battery width direction BH.

Each of the positive electrode sheets 41 consists of a positive current collecting foil made from an aluminum foil, and positive active material layers including positive active material particles and respectively formed on both main surfaces of the positive current collecting foil. A part of the positive current collecting foil extends to one side BH1 in the battery width direction BH and provides a positive-electrode foil exposed portion that is exposed without the positive active material layers present on both main surfaces of the positive current collecting foil. The positive-electrode foil exposed portions of the respective positive electrode sheets 41 are stacked in the foil thickness direction, to form a positive current collector 40c. The positive current collector 40c is conductively connected to the terminal member 50 described below.

Each of the negative electrode sheets 42 consists of a negative current collecting foil made from a copper foil, and negative active material layers including negative active material particles and respectively formed on both main surfaces of the negative current collecting foil. A part of the negative current collecting foil extends to the other side BH2 in the battery width direction BH and provides a negative-electrode foil exposed portion that is exposed without the negative active material layers present on both main surfaces of the negative current collecting foil. The negative-electrode foil exposed portions of the respective negative electrode sheets 42 are stacked in the foil thickness direction, to form a negative current collector 40d. The negative current collector 40d is conductively connected to the terminal member 60 described below.

Portions of the case lid member 30 near its ends on one side BH1 and the other side BH2 in the battery width direction BH respectively have rectangular insertion holes 30h1, 30h2 extending through the case lid member 30. The terminal member 50 of the positive electrode made of aluminum is inserted through the one insertion hole 30h1, and the terminal member 50 is fixed to the case lid member 30 while being insulated from the case lid member 30 via the resin member 70. Also, the terminal member 60 of the negative electrode made of copper is inserted through the other insertion hole 30h2, and the terminal member 60 is fixed to the case lid member 30 while being insulated from the case lid member 30 via the resin member 80.

Each terminal member 50, 60 (see FIG. 1, FIG. 2, FIG. 3A, and FIG. 3B) is formed by pressing a metal plate (an aluminum plate on the positive electrode and a copper plate on the negative electrode). The terminal member 50, 60 consists of a terminal outer portion 51, 61 in the form of a rectangular plate extending in the battery width direction BH and the battery thickness direction CH and located on the outer side (the upper side AH1 in the battery height direction AH) of the case lid member 30, a terminal inner portion 53, 63 located on the inner side (the lower side AH2 in the battery height direction AH) of the case lid member 30 and extending in the battery height direction AH, and a terminal seal portion 52, 62 that connects to the terminal outer portion 51, 61 and the terminal inner portion 53, 63 via the insertion hole 30h1, 30h2. The terminal seal portion 52, 62 is bent at an end portion of the terminal outer portion 51, 61 on one side CH1 in the battery thickness direction CH and extends to the lower side AH2 through the resin member 70, 80 described below in the battery height direction AH. The terminal inner portion 53 of the positive electrode is welded at its distal end portion on the lower side AH2 to the positive current collector 40c of the electrode body 40, to be conductively connected to the positive current collector 40c. The terminal inner portion 63 of the negative electrode is welded at its distal end portion on the lower side AH2 to the negative current collector 40d of the electrode body 40, to be conductively connected to the negative current collector 40d.

The surface 51m, 61m of the terminal outer portion 51, 61 has a rectangular top surface 51ma, 61ma that faces to the upper side AH1, a rectangular inner surface 51mb, 61mb that faces to the lower side AH2, and an end surface 51mc, 61mc that connects the top surface 51ma, 61ma and the inner surface 51mb, 61mb, and the terminal outer portion 51, 61 is joined at the inner surface 51mb, 61mb and the end surface 51mc, 61mc to the resin member 70, 80. In this embodiment, terminal nanocolumns that will be described below are not formed on the inner surface 51mb, 61mb and the end surface 51mc, 61mc.

On the other hand, the resin member 70, 80 is hermetically joined to the terminal seal portion 52, 62. Specifically, the surface 52m, 62m of the terminal seal portion 52, 62 has a first major surface 52ma, 62ma that faces to one side CH1 in the battery thickness direction CH, a second major surface 52mb, 62mb that faces to the other side CH2 in the battery thickness direction CH, and a pair of end surfaces 52mc, 62mc that connects the first major surface 52ma, 62ma and the second major surface 52mb, 62mb. As shown in FIG. 4, particles 55p, 65p derived from metal (aluminum on the positive electrode and copper on the negative electrode) that forms the terminal member 50, 60 are joined together like strings of beads, into the form of columns, so that the terminal nanocolumns 55, 65 stand together in large numbers on the surface 52m, 62m.

More specifically, the terminal nanocolumn 55 of the positive electrode consists of the particles 55p made of aluminum and aluminum oxide, and the terminal nanocolumn 65 of the negative electrode consists of the particle 65p made of copper and copper oxide. The diameter Da of each particle 55p, 65p is equal to or smaller than 100 nm (Da is equal to about 30 nm in this embodiment), and the height ha of the terminal nanocolumn 55, 65 is equal to or larger than 50 nm (ha is equal to about 200 nm in this embodiment). Gaps between the numerously standing terminal nanocolumns 55, 65 are filled with a resin material 75, so that the resin member 70, 80 described below is hermetically joined to the terminal seal portion 52, 62.

The resin member 70, 80 is also hermetically joined to a lid seal portion 31, 32 of the case lid member 30 which surrounds the insertion hole 30h1, 30h2 (see FIG. 3A and FIG. 3B). Specifically, the lid seal portion 31, 32 has a rectangular, band-like outer surface 31m, 32m that faces outward (to the upper side AH1), and a rectangular, band-like inner surface 31n, 32n that faces inward (to the lower side AH2). On these surfaces 31m, 31n, 32m, 32n, like the surface 52m of the terminal seal portion 52 of the positive electrode (see FIG. 4), lid nanocolumns 35 formed by joining particles 35p made of aluminum and aluminum oxide together like strings of beads stand together in large numbers. The diameter Da of each particle 35p is equal to or smaller than 100 nm (Da is equal to about 30 nm in this embodiment), and the height ha of the lid nanocolumn 35 is equal to or larger than 50 nm (ha is equal to about 200 nm in this embodiment). Gaps between the numerously standing lid nanocolumns 35 are filled with the resin material 75, so that the resin member 70, 80 described below is hermetically joined to the lid seal portion 31, 32.

Next, the resin member 70, 80 will be described (see FIG. 1 to FIG. 4). The resin member 70, 80 is joined to the case lid member 30 and the terminal member 50, 60 and fixes the terminal member 50, 60 to the case lid member 30, while insulating the case lid member 30 and the terminal member 50, 60 from each other. More specifically, the resin member 70, 80 is hermetically joined to the terminal seal portion 52, 62 such that gaps between the numerously standing terminal nanocolumns 55, 65 of the terminal seal portion 52, 62 of the terminal member 50, 60 are filled with the resin material 75 described below. The resin member 70, 80 is also hermetically joined to the lid seal portion 31, 32 such that gaps between the numerously standing lid nanocolumns 35 of the lid seal portion 31, 32 of the case lid member 30 are filled with the resin material 75.

The resin member 70, 80 consists of a resin outer portion 71, 81 located on the outer side (the upper side AH1) of the case lid member 30, and a resin inner portion 72, 82 that is located on the inner side (the lower side AH2) of the case lid member 30 and within the insertion hole 30h1, 30h2 and connects to the resin outer portion 71, 81.

The resin member 70, 80 is made of the resin material 75 including a thermoplastic main resin 76 having a first glass transition temperature Tg1, a thermoplastic elastomer 77 having a second glass transition temperature Tg2 and a third glass transition temperature Tg3, and a filler 78. The first glass transition temperature Tg1 of the main resin 76 is equal to or higher than 70° C. (Tg1≥70). The second glass transition temperature Tg2 of the elastomer 77 is equal to or higher than −10° C. and equal to or lower than 20° C. (−10≤Tg2≤20), and the third glass transition temperature Tg3 is equal to or lower than −40° C. (Tg3≤−40), and further, equal to or lower than −60° C. (Tg3≤−60).

Specifically, in this embodiment, the main resin 76 is polyphenylene sulfide (PPS), and the first glass transition temperature Tg1 is equal to 90° C.

The elastomer 77 is a thermoplastic polyurethane elastomer (TPU) obtained from 4,4′diphenylmethane diisocyanate (MDI) and polyester diol (PES). The elastomer 77 has two glass transition temperatures, and the second glass transition temperature Tg2 as one of the two glass transition temperatures is equal to 10° C., while the third glass transition temperature Tg3 as the other thereof is equal to −70° C.

The filler 78 is a glass filler that is fibrous (generally, 10 μm in diameter ×300 μm in length) and made of alkali glass.

The weight ratio of the main resin 76, elastomer 77, and filler 78 is as follows: main resin:elastomer:filler=40:10:50.

Next, the linear expansion coefficient «α3 of the resin material 75 will be described. The temperature range of each of the linear expansion coefficients α1, α21, α22, α3 described below is −40° C. to 65° C. Compared to the linear expansion coefficient α1 of aluminum that forms the case lid member 30 and the linear expansion coefficient «21 of aluminum that forms the terminal member 50 of the positive electrode, the linear expansion coefficient α3 of the resin material 75 that forms the resin member 70 of the positive electrode is within the range of α1±0.8×10⁻⁵ (1/K) and α21+0.8×10⁻⁵ (1/K). Compared to the linear expansion coefficient α1 of aluminum that forms the case lid member 30 and the linear expansion coefficient α22 of copper that forms the terminal member 60 of the negative electrode, the linear expansion coefficient α3 of the resin material 75 that forms the resin member 80 of the negative electrode is within the range of α1+0.8×10⁻⁵ (1/K) and α22+0.8 ×10⁻⁵ (1/K).

Specifically, in this embodiment, the linear expansion coefficient α1 of aluminum that forms the case lid member 30 and the linear expansion coefficient α21 of aluminum that forms the terminal member 50 of the positive electrode are α1=α21=2.4×10⁻⁵ (1/K). The linear expansion coefficient α22 of copper that forms the terminal member 60 of the negative electrode is α22=1.7×10⁻⁵ (1/K). On the other hand, the linear expansion coefficient α3 of the resin material 75 that forms the resin member 70, 80 is α3=2.3×10⁻⁵ (1/K). Thus, the relationships between the linear expansion coefficients α1, α21, α22, α3 are α3=a1−0.1×10⁻⁵ (1/K), α3=α21−0.1×10⁻⁵ (1/K), and α3=α22+0.6×10⁻⁵ (1/K), and these relationships satisfy the above-mentioned relationships that α3=α1+0.8×10⁻⁵ (1/K), and

$$α3 = α21 \pm 0.8 \times {10}^{- 5} ( 1 / K ) , α22 \pm 0.8 \times {10}^{- 5} ( 1 / K ) .$$

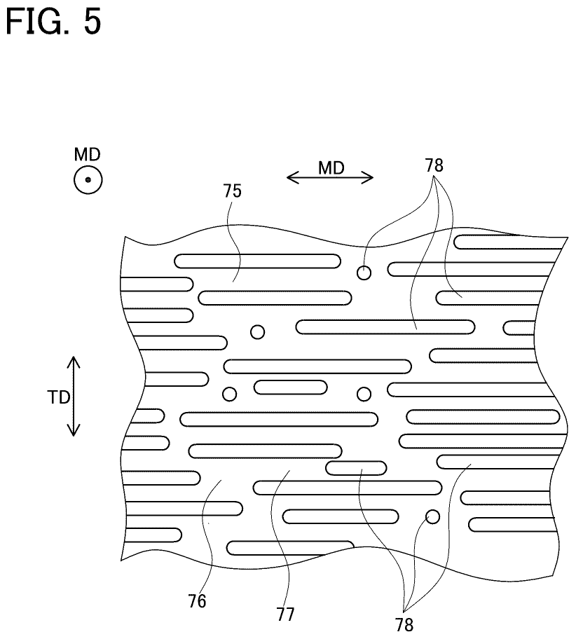

Here, a method of measuring the linear expansion coefficient α3 of the resin material 75 will be described (see FIG. 5). In this embodiment, the filler 78 included in the resin material 75 is fibrous; therefore, when the filler 78 dispersed in the resin material 75 is oriented, the linear expansion coefficient 3 of the resin material 75 becomes directional. That is, when the filler 78 is oriented in the directions in which the plane extends, the first-direction linear expansion coefficient αM measured in the first directions MD (in FIG. 5, the lateral direction and the direction orthogonal to the plane of paper) along the longitudinal direction of the filler 78 and the second-direction linear expansion coefficient αT measured in the second direction TD (in FIG. 5, the vertical direction) orthogonal to the first directions MD have different magnitudes. Thus, the first-direction linear expansion coefficient αM and the second-direction linear expansion coefficient «T are respectively obtained, and the average value is calculated as the linear expansion coefficient α3 (α3=(αM+αT)/2).

More specifically, the first-direction linear expansion coefficient αM and the second-direction linear expansion coefficient αT of the resin material 75 are obtained by a digital image correlation method (DIC). First, a rectangular parallelepiped test specimen of the resin material 75 in which the filler 78 is oriented in the directions in which the plane extends is prepared. The test specimen is placed on a specimen cooling and heating stage (e.g., Large Specimen Cooling and Heating Stage for Microscope10083L manufactured by Japan High Tech Co., Ltd.), such that a cross section (see FIG. 5) taken along the first direction MD and the second direction TD is visible. Then, an initial image of the cross section of the test specimen is acquired for the test specimen at 25° C. The image is acquired using, for example, Digital Microscope VHX-8000 manufactured by Keyence Corporation.

Then, the specimen is cooled to −40° C. and then heated to 65° C., and images of the cross section of the test specimen are acquired at −40° C., 0° C., 25° C., 50° C., and 65° C., respectively. Then, the obtained images are analyzed using a DIC system (e.g., DIC System ARAMIS manufactured by GOM) to obtain an approximate straight line y=ax+b indicating the relationship between the temperature x and the strain y for the first direction MD, and the slope a of the straight line is determined as the first-direction linear expansion coefficient αM for the first direction MD. For the second direction TD, too, an approximate straight line y=cx+d indicating the relationship between the temperature x and the strain y is obtained, and the slope c of the straight line is determined as the second-direction linear expansion coefficient αT for the second direction TD. Furthermore, the average value of these coefficients is calculated ((αM+αT)/2), and this value is determined as the linear expansion coefficient a3.

In the battery 1 of this embodiment, the main resin 76 as part of the resin material 75 that forms the resin members 70, 80 has the first glass transition temperature Tg1 that is equal to or higher than 70° C., while the elastomer 77 has the second glass transition temperature Tg2 that is equal to or higher than −10° C. and equal to or lower than 20° C. and the third glass transition temperature Tg3 that is equal to or lower than −40° C. With this arrangement, when the battery 1 is placed at room temperature (25° C.), formation of cracks in the resin members 70, 80 can be curbed. The reason for this will be described in “Test Results” below.

Furthermore, in this embodiment, the third glass transition temperature Tg3 is set to be equal to or lower than −60° C. (Tg3≤−60 (° C.)), which is sufficiently lower than the lower limit temperature (−40° C. to −20° C.) of the cooling and heating cycle test. Therefore, since the elastomer 77 remains moderately soft even at the lower limit temperature mentioned above, the stress-reducing effect of the elastomer 77 can be maintained, and formation of cracks in the resin members 70, 80 can be curbed. As a result, a good seal between the terminal member 50, 60 and the resin member 70, 80 can be maintained even when the battery 1 is subjected to the cooling/heating cycle test in which the lower limit temperature is about −40° C. to −20° C. The cooling/heating cycle test will be described below.

In this embodiment, the terminal nanocolumns 55, 65 stand together in large numbers on the surface 52m, 62m of the terminal seal portion 52, 62 of the terminal member 50, 60, and the gaps between the terminal nanocolumns 55, 65 are filled with the resin material 75, so that the resin member 70, 80 is hermetically joined to the terminal seal portion 52, 62. With this arrangement, the joint strength of the terminal seal portion 52, 62 of the terminal member 50, 60 and the resin member 70, 80 can be increased, and a good seal between the terminal member 50, 60 and the resin member 70, 80 can be maintained.

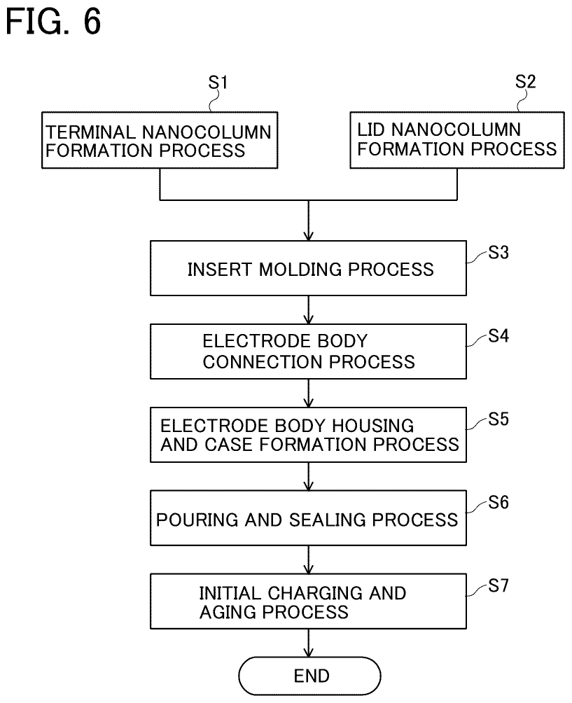

Next, a method of manufacturing the battery 1 will be described (see FIG. 6 to FIG. 8B). First, a case lid member (one example of the case member of the disclosure) 30Z before roughening is prepared. The case lid member 30Z before roughening is obtained by punching an aluminum plate into a predetermined shape and forming the liquid inlet 30k, insertion holes 30h1, 30h2, and the safety valve 11 in it. Terminal members 50Z, 60Z before roughening are also prepared. The terminal member 50Z of the positive electrode before roughening is obtained by punching an aluminum plate into a predetermined shape and bending it. The terminal member 60Z of the negative electrode before roughening is obtained by punching a copper plate into a predetermined shape and bending it.

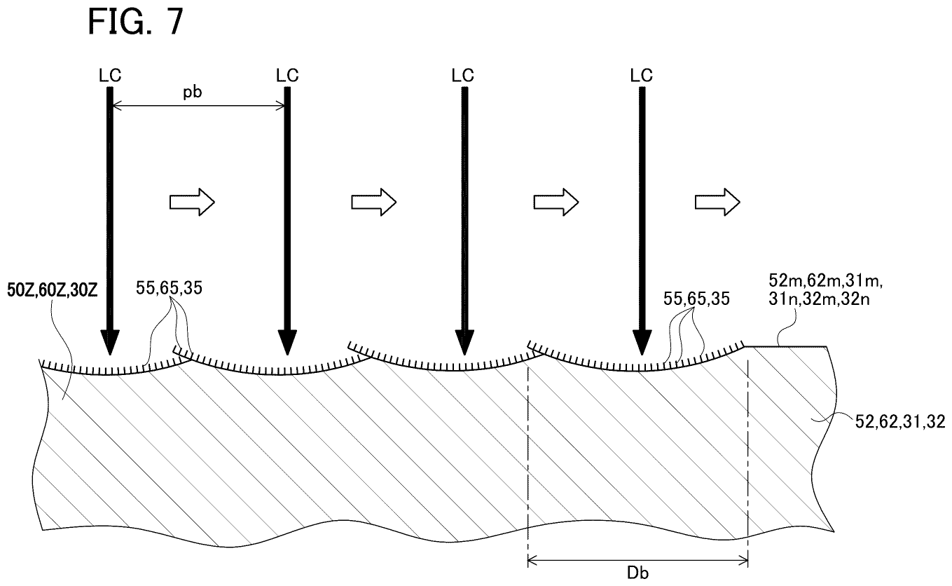

Then, in “terminal nanocolumn formation process S1” (see FIG. 6), a pulse oscillation laser beam LC is applied to the terminal seal portions 52, 62 of the terminal members 50Z, 60Z while shifting the irradiation position (see FIG. 7) to form the numerously standing terminal nanocolumns 55, 65 on the surfaces 52m, 62m of the terminal seal portions 52, 62. As described above (see also FIG. 4), the terminal nanocolumns 55, 65 are formed by joining the particles 55p, 65p together like strings of beads, into the form of columns.

In this embodiment, the irradiation conditions of the laser beam for the positive electrode are set as follows: the wavelength is 1064 nm, the peak power is 5 kW, the pulse width is 150 ns, the pitch pb is 75 μm, and the spot diameter Db is 80 μm. The irradiation conditions of the laser beam for the negative electrode are set as follows: the wavelength is 1064 nm, the peak power is 20 kW, the pulse width is 50 ns, the pitch pb is 60 μm, and the spot diameter Db is 75 μm. In each of the terminal seal portions 52, 62, metal (aluminum on the positive electrode, copper on the negative electrode) near the surface 52m, 62m is melted in a circular region as seen in plan view which is irradiated with the laser beam LC, and further turns into vapor. As the temperature of the vapor then decreases, the vapor turns into the particles 55p, 65p (the particles 55p of aluminum and aluminum oxide on the positive electrode, the particles 65p of copper and copper oxide on the negative electrode), which are deposited on the surface 52m, 62m of the terminal seal portion 52, 62. By applying the laser beam LC to the terminal seal portion 52, 62 while shifting the irradiation position, the particles 55p, 65p are deposited and joined together like strings of beads, into the form of columns, to form the terminal nanocolumns 55, 65 standing together in large numbers.

Meanwhile, in “lid nanocolumn formation process S2” (see FIG. 6), a pulse oscillation laser beam LC is applied to the lid seal portions 31, 32 of the case lid member 30Z while shifting the irradiation position (see FIG. 7) to form the numerously standing lid nanocolumns 35 on the outer surfaces 31m, 32m and inner surfaces 31n, 32n of the lid seal portions 31, 32. As described above (see also FIG. 4), the lid nanocolumns 35 are formed by joining the particles 35p made of aluminum and aluminum oxide together like strings of beads, into the form of columns. In this embodiment, the laser irradiation conditions are substantially identical with those under which the terminal nanocolumns 55 are formed on the terminal seal portion 52 of the positive electrode in the terminal nanocolumn formation process S1.

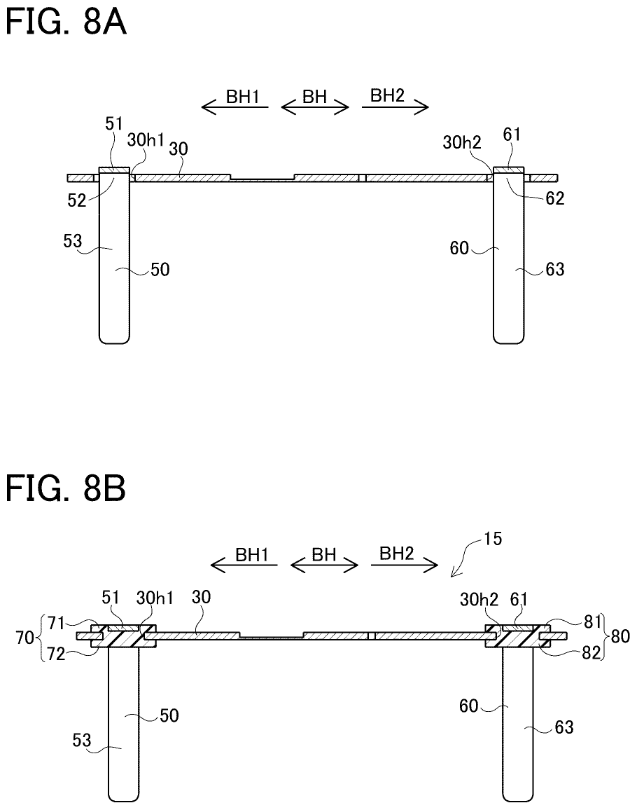

Next, in “insert molding process S3” (see FIG. 6), in a condition where the terminal members 50, 60 are inserted through the insertion holes 30h1, 30h2 of the case lid member 30, the resin members 70, 80 are formed by insert molding (see FIG. 8A and FIG. 8B), using the resin material 75 including the main resin 76 having the first glass transition temperature Tg1 mentioned above, the elastomer 77 having the second glass transition temperature Tg2 and the third glass transition temperature Tg3, and the filler 78.

More specifically, the insert molding process S3 is carried out using a molding die (not shown) having an upper die and a lower die. First, the case lid member 30 is placed at a predetermined position of the lower die, and the terminal members 50, 60 are respectively inserted through the insertion holes 30h1, 30h2 of the case lid member 30 (see FIG. 8A). Then, the upper die is moved toward the lower die to close the molding die. The molten resin material 75 is then injected into two cavities of the molding die. At this time, the resin material 75 fills gaps between the numerously standing terminal nanocolumns 55, 65 of the terminal seal portions 52, 62 and gaps between the numerously standing lid nanocolumns 35 of the lid seal portions 31, 32, to form the resin members 70, 80 hermetically joined to the terminal seal portions 52, 62 and the lid seal portions 31, 32 (see FIG. 8B). Then, a lid assembly 15 with the terminal members 50, 60 fixed to the case lid member 30 via the resin members 70, 80 is removed from the molding die.

Next, in “electrode body connection process S4” (see FIG. 6), the electrode body 40 obtained by stacking the positive electrode sheets 41, negative electrode sheets 42, and separators 43 is prepared, and the terminal inner portion 53 of the terminal member 50 as a part of the lid assembly 15 described above is welded to the positive current collector 40c of the electrode body 40. The terminal inner portion 63 of the terminal member 60 as a part of the lid assembly 15 is also welded to the negative current collector 40d of the electrode body 40. The electrode body 40 is then wrapped with the bag-like insulating holder 7.

Next, in “electrode body housing and case formation process S5,” the case body 20 is prepared, the electrode body 40 covered with the insulating holder 7 described above is inserted into the case body 20, and the opening portion 20c of the case body 20 is closed with the case lid member 30. Then, the opening portion 20c of the case body 20 and the peripheral portion 30f of the case lid member 30 are laser welded hermetically over the entire circumference to form the case 10 with the electrode body 40 housed inside.

Next, in “pouring and sealing process S6,” the electrolyte 5 is poured into the case 10 through the liquid inlet 30k, so that the electrode body 40 is impregnated with the electrolyte 5. The liquid inlet 30k is then covered from the outside with the sealing member 12, and the sealing member 12 is laser welded hermetically to the case 10.

Next, in “initial charging and aging process S7,” a charging device (not shown) is connected to the battery 1 to perform initial charging on the battery 1. Then, the initially charged battery 1 is left to stand for a predetermined time so that the battery 1 is aged. In this manner, the battery 1 is completed.

As described above, in the method of manufacturing the battery 1, the resin members 70, 80 are molded in the insert molding process S3, using the resin material 75 including the above-mentioned main resin 76, elastomer 77, and filler 78; therefore, the battery 1 can be manufactured in which formation of cracks in the resin members 70, 80 is curbed when the battery 1 is placed at room temperature (25° C.).

Furthermore, in the terminal nanocolumn formation process S1, the terminal nanocolumns 55, 65 are formed on the surfaces 52m, 62m of the terminal seal portions 52, 62 by irradiating the surfaces 52m, 62m with the laser beam LC as described above, so that the terminal nanocolumns 55, 65 can be easily formed on the terminal seal portions 52, 62. Since the resin members 70, 80 are molded with the resin material 75 filling gaps between the terminal nanocolumns 55, 65 in the insert molding process S3, the joint strength of the terminal seal portions 52, 62 of the terminal members 50, 60 and the resin members 70, 80 can be increased, and good seals between the terminal members 50, 60 and the resin members 70, 80 can be maintained.

### Test Results

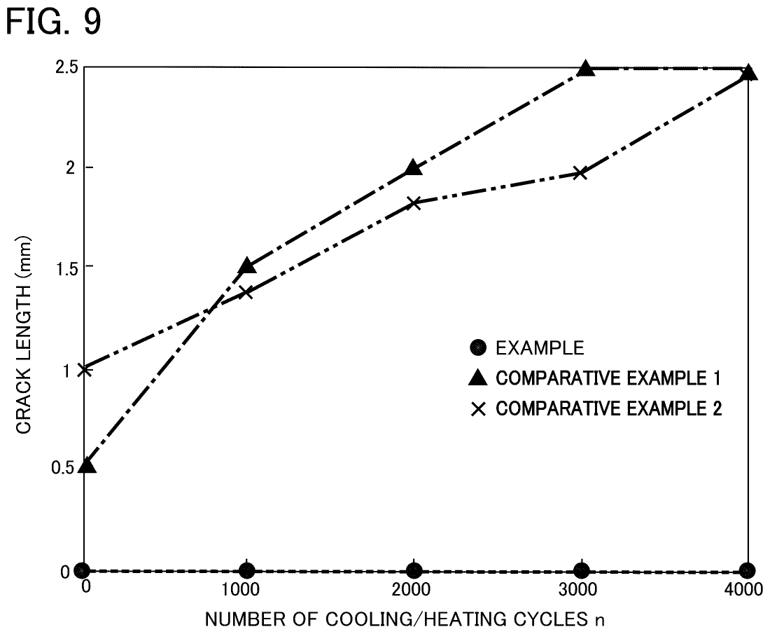

Next, the results of tests conducted to verify the effects of the disclosure will be described (see FIG. 9). As Example, the lid assembly 15 (see FIG. 8B) according to the embodiment described above was prepared. Specifically, the terminal nanocolumn formation process S1, the lid nanocolumn formation process S2, and the insert molding process S3 were performed to obtain the lid assembly 15 in which the terminal members 50, 60 were fixed to the case lid member 30 via the resin members 70, 80. The resin material 75 used for insert molding includes the main resin 76 having the first glass transition temperature Tg1 (=90° C.), the elastomer 77 having the second glass transition temperature Tg2 (=10° C.) and the third glass transition temperature Tg3 (=−70° C.), and the filler 78. In Example, the first glass transition temperature Tg1 (=90° C.) satisfies Tg1≥70 (° C.), the second glass transition temperature Tg2 (=10° C.) satisfies −10≤Tg2≤20 (° C.), and the third glass transition temperature Tg3 (=−70° C.) satisfies Tg3≤−40 (° C.).

On the other hand, as Comparative Example 1, the resin material 75 including the main resin 76 having the first glass transition temperature Tg1 (=90° C.), the elastomer 77 having the second glass transition temperature Tg2 (=−60° C.) and the third glass transition temperature Tg3 (=−80° C.), and the filler 78 was prepared and used to form the lid assembly 15 described above in the same manner as in Example except for the resin material 75. In Comparative Example 1, the first glass transition temperature Tg1 (=90° C.) satisfies Tg1≥70 (° C.), and the third glass transition temperature Tg3 (=−80° C.) satisfies Tg3≤−40 (° C.), but the second glass transition temperature Tg2 (=−60° C.) does not satisfy −10≤Tg2≤20 (° C.).

As Comparative Example 2, the resin material 75 including the main resin 76 having the first glass transition temperature Tg1 (=90° C.), the elastomer 77 having only the second glass transition temperature Tg2 (=−10° C.), and the filler 78 was prepared and used to form the lid assembly 15 in the same manner as in Example except for the resin material 75. In Comparative Example 2, the first glass transition temperature Tg1 (=90° C.) satisfies Tg1≥ 70 (° C.), and the second glass transition temperature Tg2 (=−10° C.) satisfies −10≤Tg2≤20 (C), but there is no third glass transition temperature; therefore, Tg3≤−40 (° C.) is not satisfied.

Then, the lid assemblies 15 of Example and Comparative Examples were held under room temperature (25° C.) (the temperature of the resin members 70, 80 was controlled to room temperature), and the length of cracks generated in a region of the resin member 70 of the positive electrode near its boundary with the terminal member 50 and the length of cracks generated in a region of the resin member 80 of the negative electrode near its boundary with the terminal member 60 were respectively measured. As a result, in Example, no cracks appeared in either of the resin members 70, 80. As shown in FIG. 9, the crack length is equal to 0.0 mm at n=0 where “n” represents the number of cooling/heating cycles. On the other hand, in Comparative Example 1, cracks of 0.5 mm appeared in both of the resin members 70, 80. In Comparative Example 2, cracks of 1.0 mm appeared in both of the resin members 70, 80.

Then, the lid assemblies 15 were subjected to the cooling/heating cycle test in the temperature range from the lower limit temperature of −40° C. to the upper limit temperature of 65° C., taking account of the operating temperature conditions of the battery 1. More specifically, each lid assembly was subjected to 4000 cycles of cooling and heating, using a liquid bath tester, such that the lid assembly was immersed in a liquid bath at −40° C. for three minutes and then immersed in a liquid bath at 65° C. for three minutes in one cycle. Then, the length of cracks generated in the resin members 70, 80 was measured as described above, after the number of cooling/heating cycles reached 1000, 2000, 3000, and 4000, respectively. The results are all shown in FIG. 9.

In this test, there was no difference in the size of cracks between the resin member 70 of the positive electrode and the resin member 80 of the negative electrode; therefore, in FIG. 9, the test results are indicated without distinguishing the resin member 70 from the resin member 80. Since the seal length between the terminal member 50, 60 and the resin member 70, 80 is 2.5 mm, the maximum length of cracks in this test is 2.5 mm (when the crack length is 2.5 mm, the seal between the terminal member 50, 60 and the resin member 70, 80 is broken).

As is apparent from the graph in FIG. 9, in Example, no cracks appeared in the resin members 70, 80 even after the cooling/heating cycle test was conducted. On the other hand, in Comparative Example 1, the length of cracks increased as the number of cooling/heating cycles “n” increased, and, when the number of cooling/heating cycles “n” was equal to 3000, the crack length reached 2.5 mm and the seals between the terminal members 50, 60 and the resin members 70, 80 were broken. In Comparative Example 2, the length of cracks increased as the number of cooling/heating cycles “n” increased, and, when the number of cooling/heating cycles “n” was equal to 4000, the crack length reached 2.5 mm and the seals between the terminal members 50, 60 and the resin members 70, 80 were broken.

The reasons for the results are considered as follows. The main resin 76 included in the resin material 75 has the first glass transition temperature Tg1 (=90° C.) sufficiently higher than room temperature in any of Example and Comparative Examples 1, 2; therefore, the main resin 76 is in a glassy state under room temperature and is hard and strong but has low toughness.

In Comparative Example 2, the elastomer 77 has only the second glass transition temperature Tg2, and the second glass transition temperature Tg2 (=−10° C.) is within the range of −10° C. or higher (within the range higher or slightly lower than room temperature). In this case, where the resin members 70, 80 are at room temperature, the elastomer 77 is in a hard state even though it is not in a glassy state. Therefore, the resin members 70, 80 are also hard and have high elasticity, and it follows that large stress was applied to the resin members 70, 80 due to thermal expansion differences between the case lid member 30 and terminal members 50, 60 and the resin members 70, 80, resulting in cracks in the resin members 70, 80. Furthermore, it may be considered that, by repeatedly changing the temperature of the lid assembly 15 in the cooling/heating cycle test, the cracks extended, and the seals between the terminal members 50, 60 and the resin members 70, 80 were broken.

In Comparative Example 1, the elastomer 77 has the second glass transition temperature Tg2 (=−60° ° C.) and the third glass transition temperature Tg3 (=−80° C.), but both temperatures Tg2, Tg3 (below −40° C.) are sufficiently lower than room temperature. In this case, the elastomer 77 is in a sufficiently soft rubber-like elastic state where the resin members 70, 80 are at room temperature. Therefore, when there are thermal expansion differences between the case lid member 30 and terminal members 50, 60 and the resin members 70, 80, the elastomer 77, which is too soft and deforms easily, cannot sufficiently disperse stress; as a result, large stress was applied to the main resin 76 of the resin members 70, 80, and cracks formed in the resin members 70, 80. Furthermore, it may be considered that, by repeatedly changing the temperature of the lid assembly 15 in the cooling/heating cycle test, the cracks extended, and the seals between the terminal members 50, 60 and the resin members 70, 80 were broken.

In contrast, in Example, the elastomer 77 has the second glass transition temperature Tg2 (=10° C.) that is slightly lower than room temperature (−10 to 20° C.), and the third glass transition temperature Tg3 (=−70° C.) (≤−40° C.) that is sufficiently lower than room temperature. Therefore, where the resin members 70, 80 are at room temperature, a part of the elastomer 77 is hard because the second glass transition temperature Tg2 (=10° C.) is close to room temperature, but the rest of the elastomer 77 remains sufficiently soft because the third glass transition temperature Tg3 (=−70° C.) is sufficiently lower than room temperature. Thus, the elastomer 77 as a whole may be considered to be moderately hard (moderately soft). As a result, even with the thermal expansion differences between the case lid member 30 and terminal members 50, 60 and the resin members 70, 80, the elastomer 77 with moderate hardness deformed and dispersed stress, so that the stress on the main resin 76 of the resin members 70, 80 was reduced, and no cracks appeared in the resin members 70, 80.

Furthermore, in Example, the third glass transition temperature Tg3 (=−70° C.) of the elastomer 77 is sufficiently lower than the lower limit temperature (−40° C.), namely, Tg3≤−60 (° C.). Therefore, the elastomer 77 remains moderately soft even at the lower limit temperature (−40° C.), so that the stress-reducing effect of the elastomer 77 can be maintained and cracks can be prevented from appearing in the resin members 70, 80. Thus, it may be considered that good seals between the terminal members 50, 60 and the resin members 70, 80 could be maintained even after the cooling/heating cycle test.

While the disclosure has been described in the light of the embodiment, it is to be understood that the disclosure is not limited to the embodiment, but may be applied by making changes as needed, without departing from the principle of the disclosure.

### REFERENCE SIGNS LIST

1 Battery (Power storage device)
10 Case
30 Case lid member (Case member)
30h1, 30h2 Insertion hole
40 Electrode body
50, 60 Terminal member
52, 62 Terminal seal portion
52m, 62m Surface (of terminal seal portion)
55,65 Terminal nanocolumn
55p, 65p Particle
70, 80 Resin member
75 Resin material
76 Main resin
77 Elastomer
78 Filler
α Linear expansion coefficient
LC Laser beam
S1 Terminal nanocolumn formation process
S3 Insert molding process

What is claimed is:

1. A power storage device comprising:
a case member having an insertion hole;
a terminal member inserted through the insertion hole of the case member; and
a resin member subjected to insert molding and hermetically joined to the case member and the terminal member while insulating the case member and the terminal member from each other, to fix the terminal member to the case member,
wherein the resin member comprises a resin material including a thermoplastic main resin having a first glass transition temperature Tg1 that is equal to or higher than 70° C. (Tg1≥70), a thermoplastic elastomer, and a filler, and
wherein the elastomer has a second glass transition temperature Tg2 that is equal to or higher than −10° C. and equal to or lower than 20° C. (−10≤Tg2≤20) and a third glass transition temperature Tg3 that is equal to or lower than −40° C. (Tg3≤−40).

2. The power storage device according to claim 1, wherein the third glass transition temperature Tg3 is equal to or lower than −60° C. (Tg3≤−60).

3. The power storage device according to claim 1, wherein:
the terminal member includes a terminal seal portion to which the resin member is hermetically joined;
terminal nanocolumns with a height of 50 nm or more formed by joining particles derived from a metal that forms the terminal member and having a diameter of 100 nm or less together like strings of beads, into the form of columns, stand numerously on a surface of the terminal seal portion; and
the resin member is hermetically joined to the terminal seal portion with the resin material filling gaps between the terminal nanocolumns standing numerously.

4. A method of manufacturing a power storage device including
a case member having an insertion hole,
a terminal member inserted through the insertion hole of the case member, and
a resin member subjected to insert molding and hermetically joined to the case member and the terminal member while insulating the case member and the terminal member from each other, to fix the terminal member to the case member,
wherein the resin member comprises a resin material including a thermoplastic main resin having a first glass transition temperature Tg1 that is equal to or higher than 70° C. (Tg1≥70), a thermoplastic elastomer, and a filler, and
wherein the elastomer has a second glass transition temperature Tg2 that is equal to or higher than −10° C. and equal to or lower than 20° C. (−10≤Tg2≤20) and a third glass transition temperature Tg3 that is equal to or lower than −40° C. (Tg3≤−40),
the method including
an insert molding of insert molding the resin member in a condition where the terminal member is inserted through the insertion hole of the case member,
wherein the insert molding comprises molding the resin member, using the resin material including the main resin having the first glass transition temperature Tg1, the elastomer having the second glass transition temperature Tg2 and the third glass transition temperature Tg3, and the filler.

5. The method according to claim 4, wherein:
the terminal member includes a terminal seal portion to which the resin member is hermetically joined;
terminal nanocolumns with a height of 50 nm or more formed by joining particles derived from a metal that forms the terminal member and having a diameter of 100 nm or less together like strings of beads, into the form of columns, stand numerously on a surface of the terminal seal portion; and
the resin member is hermetically joined to the terminal seal portion with the resin material filling gaps between the terminal nanocolumns standing numerously, the method further including
a terminal nanocolumn forming of applying a pulse oscillation laser beam to the terminal seal portion of the terminal member while shifting an irradiation position, to form the terminal nanocolumns standing numerously on the terminal seal portion, before the insert molding,
wherein the insert molding comprises molding the resin member while filling gaps between the terminal nanocolumns standing numerously on the terminal seal portion with the resin material.

6. The power storage device according to claim 2, wherein:
the terminal member includes a terminal seal portion to which the resin member is hermetically joined;
terminal nanocolumns with a height of 50 nm or more formed by joining particles derived from a metal that forms the terminal member and having a diameter of 100 nm or less together like strings of beads, into the form of columns, stand numerously on a surface of the terminal seal portion; and
the resin member is hermetically joined to the terminal seal portion with the resin material filling gaps between the terminal nanocolumns standing numerously.
